(19) United States
(12) Patent Application Publication
(10) Pub. No.: US 2024/0219871 A1
(43) Pub. Date: Jul. 4, 2024

(54) ANALYSIS METHOD

(71) Applicant: CANON KABUSHIKI KAISHA, Tokyo (JP)

(72) Inventor: YOSHIHIRO SHIODE, Tochigi (JP)

(21) Appl. No.: 18/603,316

(22) Filed: Mar. 13, 2024

Related U.S. Application Data
(63) Continuation of application No. PCT/JP22/34245, filed on Sep. 13, 2022.

(30) Foreign Application Priority Data
Sep. 22, 2021 (JP) 2021-154714

(51) Int. Cl. G05B 13/02; G03F 7/00; G03F 7/16; G05B 19/418

(52) U.S. Cl. CPC G05B 13/0265; G03F 7/0002; G03F 7/162; G05B 19/41885

(57) ABSTRACT

An analysis method of analyzing a process for manufacturing a semiconductor device, includes a preparing step of preparing a plurality of data sets each including an input to a simulator that simulates the process and an output from the simulator, a generating step of generating, based on the plurality of data sets, a plurality of learning data having, as a value of an explanatory variable, a value of information, of process information associated with at least one of control and a state of the process, to which attention is to be paid and a value of evaluation information for evaluating the process as a valued of an objective variable, and a learning step of generating a model expressing the process by performing learning based on the plurality of learning data generated in the generating step.

### CROSS-REFERENCE TO RELATED APPLICATIONS

This application is a Continuation of International Patent Application No. PCT/JP2022/034245, filed Sep. 13, 2022, which claims the benefit of Japanese Patent Application No. 2021-154714, filed Sep. 22, 2021, both of which are hereby incorporated by reference herein in their entirety.

### BACKGROUND OF THE INVENTION

### Field of the Invention

The present invention relates to an analysis method.

### Background art

Machine learning, which has been recently attracting attention, is considered to be useful for analyzing a process for manufacturing a semiconductor device. However, an enormous amount of information is required to generate a model by machine learning, and much time and cost are required to obtain the enormous amount of information by executing an actual process.

### CITATION LIST

### Patent Literature

PTL 1 Japanese Patent Laid-Open No. 2021-27349.

### SUMMARY OF THE INVENTION

The present invention provides a technique advantageous in analyzing a process in a short period of time at low cost.

One of aspects of the present invention is related to an analysis method of analyzing a process for manufacturing a semiconductor device, and the method comprises a preparing step of preparing a plurality of data sets each including an input to a simulator that simulates the process and an output from the simulator, a generating step of generating, based on the plurality of data sets, a plurality of learning data having, as a value of an explanatory variable, a value of information, of process information associated with at least one of control and a state of the process, to which attention is to be paid and a value of evaluation information for evaluating the process as a valued of an objective variable, and a learning step of generating a model expressing the process by performing learning based on the plurality of learning data generated in the generating step.

Other features and advantages of the present invention will be apparent from the following description taken in conjunction with the accompanying drawings.

Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a view exemplifying the hardware arrangement of an analysis system according to one embodiment.

FIG. 2 is a block diagram exemplifying the hardware arrangement of a terminal and a server constituting the analysis system.

FIG. 3 is a block diagram exemplifying the logical arrangement of the analysis system according to one embodiment.

FIG. 4 is a schematic view showing the flow of data or information in the analysis system according to one embodiment.

FIG. 5 is a schematic view showing the flow of data or information in the analysis system according to one embodiment.

FIG. 6 is a view schematically showing an example of a model (learned model) generated by a learning unit.

FIG. 7 is a flowchart exemplifying the operation of the analysis system in a simulation phase, more specifically, the operation of a simulation server.

FIG. 8 is a flowchart exemplifying the operation of the analysis system in a data acquisition phase, more specifically, the operation of a data acquisition server.

FIG. 9 is a flowchart exemplifying the operation of the analysis system in a learning phase and an application phase, more specifically, the operation of an estimation server.

FIG. 10 is a view exemplifying the arrangement of an imprint apparatus.

FIG. 11 is a view exemplifying the arrangement of the driving unit of an imprint head.

FIG. 12 is a view schematically showing a state in which the mesa region of a mold is deformed into a convex shape on the substrate side.

FIG. 13 is a flowchart exemplifying imprint processing.

FIG. 14A is a view showing the experimental result obtained by observing how incomplete filling defects occur.

FIG. 14B is a view showing the experimental result obtained by observing how incomplete filling defects occur.

FIG. 14C is a view showing the experimental result obtained by observing how incomplete filling defects occur.

FIG. 15A is a view schematically showing each state shown in FIG. 16.

FIG. 15B is a view schematically showing each state shown in FIG. 16.

FIG. 15C is a view schematically showing each state shown in FIG. 16.

FIG. 16 is a graph exemplifying the relationship between a contact boundary diameter and a mold curvature shape.

FIG. 17 is a graph exemplifying the relationship between a contact boundary diameter and the tilt of a mold.

FIG. 18 is a graph showing the verification result of a generated model.

FIG. 19 is a graph showing the verification result of a generated model.

FIG. 20 is a graph showing the verification result of a generated model.

FIG. 21 is a graph showing the verification result of a generated model.

FIG. 22 is a view for explaining an explanatory variable.

FIG. 23 is a view for explaining an objective variable.

FIG. 24 is a view exemplifying a parent database.

FIG. 25 is a view exemplifying a database list for each module.

FIG. 26 is a view exemplifying a database list for each module.

FIG. 27 is a view exemplifying a database list of apparatus information.

FIG. 28 is a view exemplifying a database of imprint profiles.

FIG. 29 is a view exemplifying a database list of the intermediate data of apparatus information.

FIG. 30 is a view exemplifying a database of curvature profiles.

FIG. 31 is a view exemplifying a database of objective variable information.

FIG. 32 is a view exemplifying a database of objective variable information.

FIG. 33 is a view exemplifying a search list for generating learning data.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

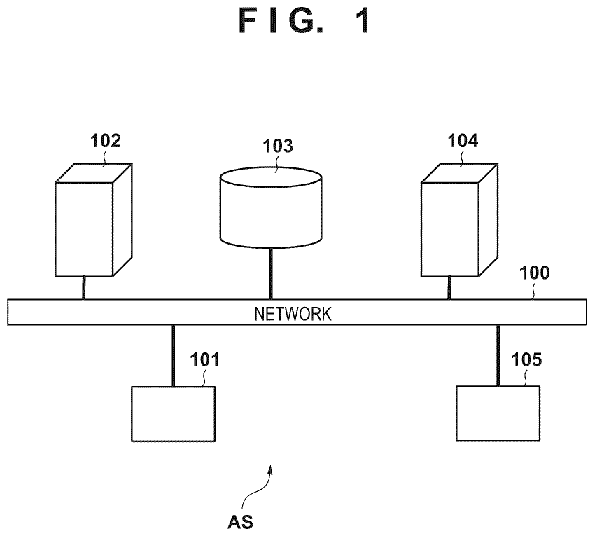

FIG. 1 is a view exemplifying the hardware arrangement of an analysis system AS according to one embodiment. The analysis system AS can have an arrangement in which, for example, one or a plurality of terminals 101 and 105 constituting a user interface are connected to a plurality of servers 102, 103, and 104 that execute data processing via a network 100. The network 100 can be of any type. The plurality of servers 102, 103, and 104 may be replaced with one computer. For example, the simulation server 102 is formed as a simulation server, the server 103 is formed as a data acquisition server, and the server 104 is formed as an estimation server. The analysis system AS will be described below based on an example configured in this manner.

The simulation server 102 includes a simulator that simulates a process for manufacturing a semiconductor device. The simulator can be configured by installing computer software in a computer or by making a computer execute computer software. The data acquisition server 103 is configured so as to acquire and accumulate data sets generated by simulations executed by the simulation server 102. The estimation server 104 performs learning based on a plurality of learning data generated from a plurality of data sets extracted or searched for from many data sets accumulated by the data acquisition server 103 and generates a model expressing a process for manufacturing a semiconductor device. The estimation server 104 also estimates the execution result of the process by using the model.

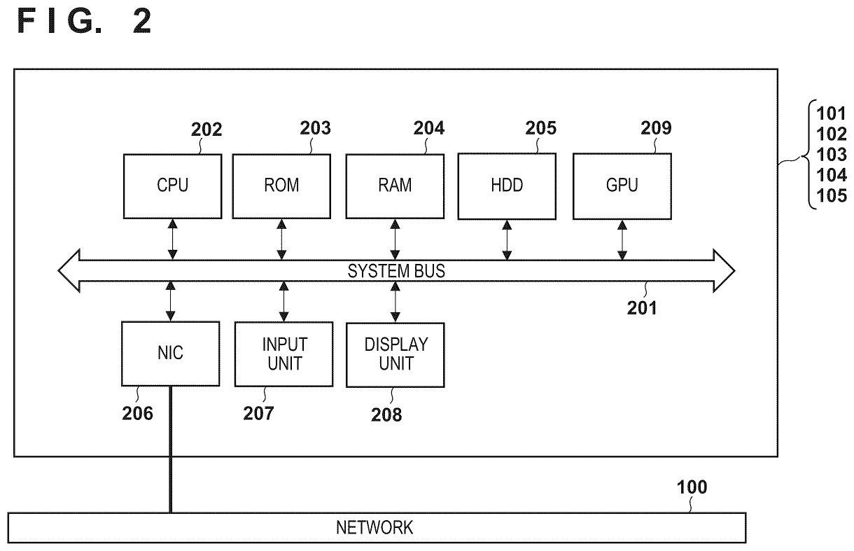

FIG. 2 exemplifies the hardware arrangement of the terminals 101 and 105 and the servers 102, 103, and 104. Note that the terminals 101 and 105 and the servers 102, 103, and 104 may have the same hardware arrangement or different hardware arrangements. The hardware arrangement can include a system bus 201, a CPU 202, a ROM 203, a RAM 204, an HDD 205, a GPU 209, an NIC 206, an input unit 207, and a display unit 208. The GPU 209 is advantageous in shortening the time required for learning and can execute an arithmetic operation together with the CPU 202.

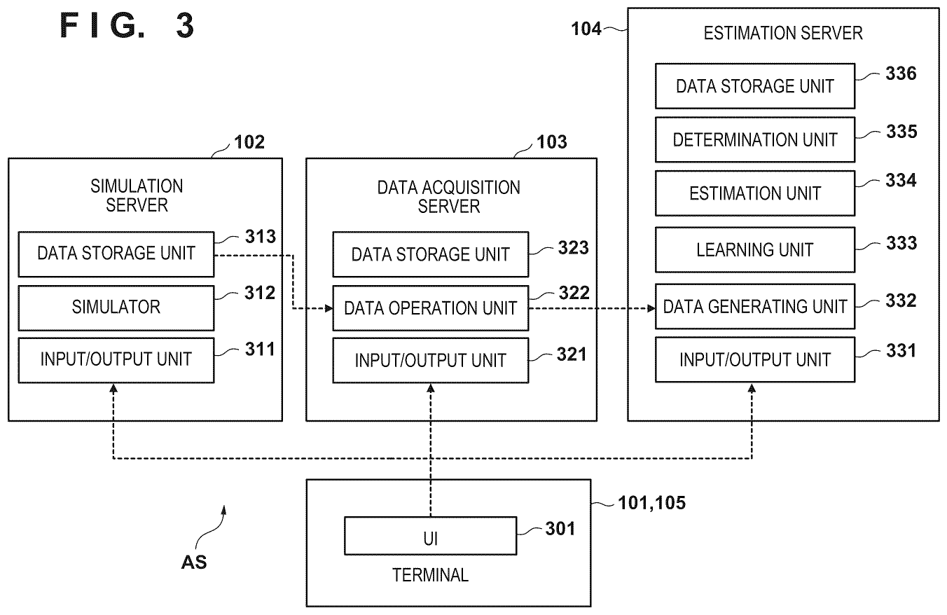

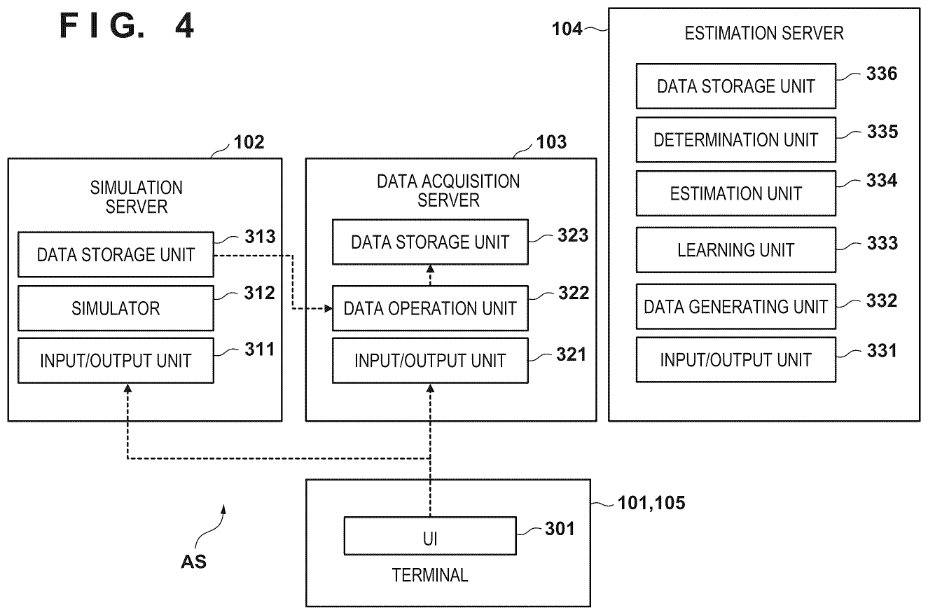

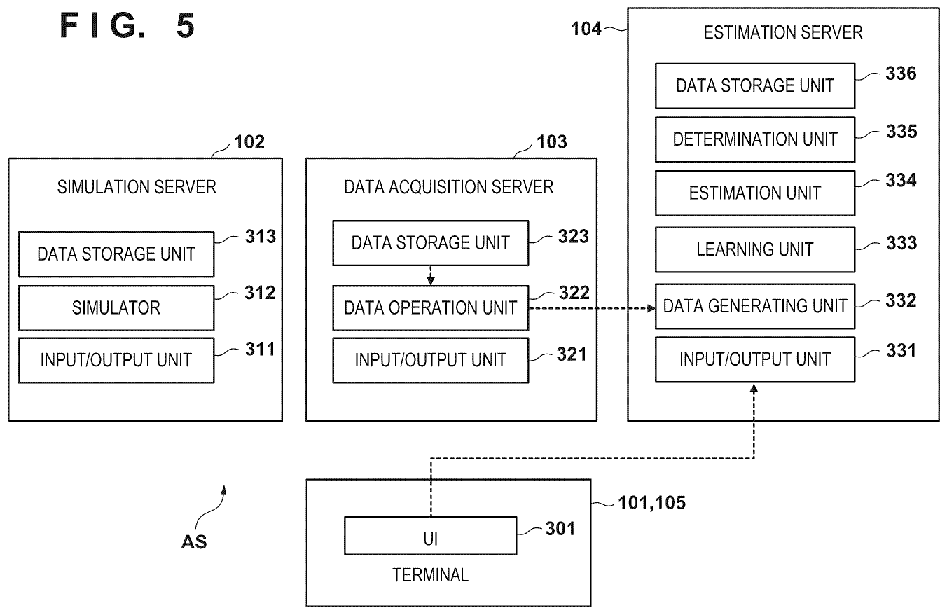

FIG. 3 shows an example of the logical arrangement of the analysis system AS configured by using the hardware arrangement shown in FIGS. 1 and 2. FIGS. 4 and 5 schematically show the flows of data or information in the analysis system AS. As described above, the analysis system AS can include one or the plurality of terminals 101 and 105, the simulation server 102, the data acquisition server 103, and the estimation server 104. The simulation server 102, the data acquisition server 103, and the estimation server 104 are respectively configured by different computers in this case but may be configured by one computer or each may be configured by a plurality of computers.

The terminals 101 and 105 each can include a user interface (UI) 301. The user can input or specify information to be provided to the simulation server 102, the data acquisition server 103, and the estimation server 104 by operating the user interface 301. Such information can include, for example, conditions for a simulation to be executed by the simulation server 102, explanatory variables and objective variables for a model to be generated by the estimation server 104, and conditions for a process to be verified by using the model.

The simulation server 102 can include an input/output unit 311, a simulator 312, and a data storage unit 313. The input/output unit 311 can receive information from the terminals 101 and 105 or the user interface 301 and transmit information to the terminals 101 and 105 or the user interface 301. The simulator 312 can generate a data set by performing a simulation of a process for manufacturing a semiconductor device (to be simply referred to as a “process” hereinafter). A data set can include an input to the simulator 312 that simulates a process and an output from the simulator 312. The data storage unit 313 temporarily stores the data set.

The data acquisition server 103 can include an input/output unit 321, a data operation unit 322, and a data storage unit 323. The input/output unit 321 can receive information from the terminals 101 and 105 or the user interface 301 and transmit information to the terminals 101 and 105 or the user interface 301. The data operation unit 322 can receive or acquire a data set generated by a simulation from the simulation server 102 and register the data set in a database configured by the data storage unit 323. In accordance with a request from the estimation server 104, the data operation unit 322 can search for a plurality of data sets matching the request from many data sets registered in the database configured by the data storage unit 323 and provide the plurality of data sets to the estimation server 104. The simulation server 102 and the data acquisition server 103 each can be understood as a device that executes a preparation step of preparing a plurality of data sets including inputs to a simulator that simulates a process and outputs from the simulator.

The estimation server 104 can include an input/output unit 331, a data generating unit 332, a learning unit 333, an estimation unit 334, a determination unit 335, and a data storage unit 336. The input/output unit 331 can receive information from the terminals 101 and 105 or the user interface 301 or transmit information to the terminals 101 and 105 or the user interface 301. The data generating unit 332 can execute a generating step of generating a plurality of learning data based on a plurality of data sets provided from the data acquisition server 103. Each learning data can have, as the value of an explanatory variable, the value of information (information of interest) of process information associated with at least one of the control and the state of a process to which attention should be paid and the value of evaluation information for evaluating the process as the value of an objective variable. The process information may be control information for controlling the process or intermediate data (information indicating the state of the process) calculated by the simulator based on the control information. The learning unit 333 can execute a learning process of generating a model expressing a process by performing learning based on a plurality of learning data generated in the generating step executed by the data generating unit 332. This model can be saved in the data storage unit 336. The estimation unit 334 can determine the value of an objective variable based on the value of the explanatory variable provided from the terminal 101 or 105 by using the model generated in the generating step executed by the learning unit 33 and provide the value of the objective variable to the terminal 101 or 105. The determination unit 335 can determine the value of an explanatory variable so as to satisfy target performance by using the model generated in the learning step executed by the learning unit 33 and provide the value of the explanatory variable to the terminal 101 or 105.

The terminal 101 or 105 can provide, to the simulation server 102, control information for controlling a process as an input to the simulator 312 and make the simulator 312 execute a simulation based on the control information. This enables the simulator 312 to generate a data set. The terminal 101 or 105 can provide various types of control information to the simulation server 102, generate many data sets by making the simulator 312 execute simulations, and accumulate the data sets in the data acquisition server 103.

The terminal 101 or 105 can provide control information for controlling a process to the estimation server 104 and make the estimation server 104 prepare a model matching the control information. If there is already a model matching the control information provided from the terminal 101 or 105, the estimation server 104 can determine evaluation information (the value of the objective variable) based on the control information (the value of the explanatory variable) and provide the evaluation information to the terminal 101 or 105. If there is no model matching the control information provided from the terminal 101 or 105, the estimation server 104 can request the data acquisition server 103 to provide a plurality of data sets for generating the learning data by learning. This request can include control information for controlling the process. The data acquisition server 103 can search for a plurality of data sets matching the request from the accumulated many data sets in accordance with a request from the estimation server 104 and provide the plurality of found data sets to the estimation server 104. If there are not accumulated a plurality of data matching a request from the estimation server 104, the data acquisition server 103 can request the simulation server 102 to generate a plurality of data sets matching the request. The simulation server 102 can execute a simulation by using the simulator 312 in accordance with the request and provide the plurality of generated data sets to the data acquisition server 103. The data acquisition server 103 can provide the plurality of data sets to the estimation server 104. The estimation server 104 can generate a plurality of learning data by using the plurality of data sets and generate a model matching the conditions provided from the terminal 101 or 105 by performing learning using the plurality of learning data.

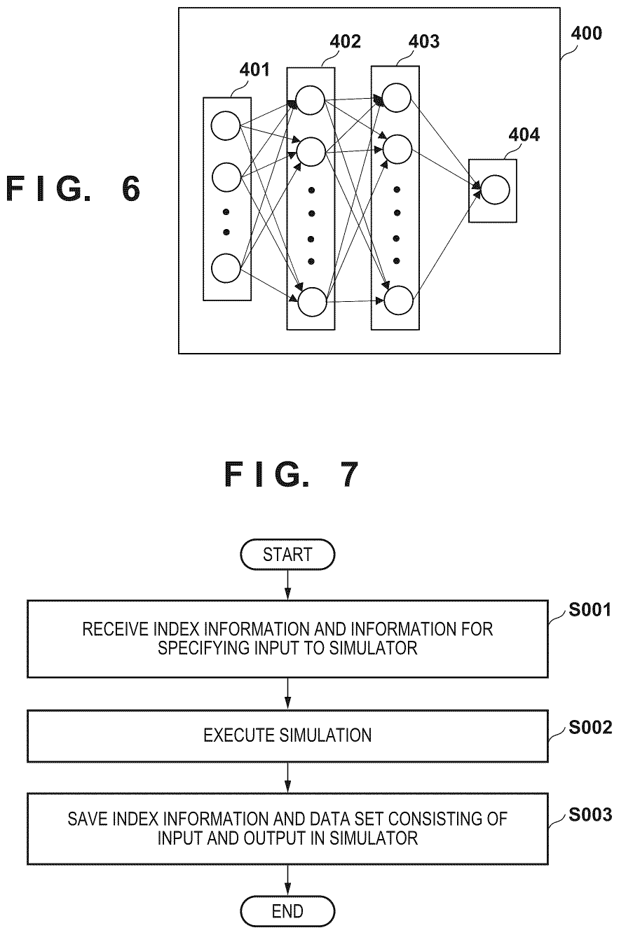

FIG. 6 schematically shows an example of a model (learned model) generated by the learning unit 333. This model can be configured by a neural network 400. The neural network 400 can include, for example, an input layer 401, two hidden layers 402 and 403, and an output layer 404. A sample for each variable used for learning is assigned to each node of the input layer 401. In the model, each node of each layer except for the input layer 401 is configured by a linear sum of weight coefficients and an activating function so as to enable nonlinear propagation through the hidden layer 402, the hidden layer 403, and the output layer 404 in this order. Learning can be executed so as to minimize the difference between the value of the output layer 404 and training data prepared for the learning. The output layer 404 is configured by one node but may include a plurality of nodes. The learning unit 333 may include an error detection unit and an updating unit. The error detection unit obtains an error between the training data and the output data output from the output layer 404 of the neural network 400 in accordance with the input data input to the input layer 401. The error detection unit may calculate an error between the output data from the neural network 400 and the training data by using a loss function. The updating unit updates coupling weight coefficients and the like between the nodes of the neural network 400 based on the error obtained by the error detection unit so as to reduce the error. This updating unit can update the coupling weight coefficients and the like by using, for example, backpropagation. Backpropagation is a technique of adjusting coupling weight coefficients and the like between the respective nodes of the neural network 400 so as to reduce the error.

FIG. 7 exemplifies the operation of the analysis system AS in a simulation phase, more specifically, the operation of the simulation server 102. In step S001, the simulation server 102 receives index information from the terminal 101 or 105 and information specifying an input (an input for a simulation) to the simulator 312. In this case, a plurality of input candidates to the simulator 312 may be held in the simulation server 102, and information provided from the terminal 101 or 105 may be information for selecting at least one of the plurality of input candidates. Index information is information for identifying the contents (conditions) of a simulation. In step S002, the simulation server 102 makes the simulator 312 execute a simulation based on the information received in step S001. In step S003, the simulation server 102 saves a data set including an input and an output in the simulation in step S002 in the data storage unit 313 in association with the index information.

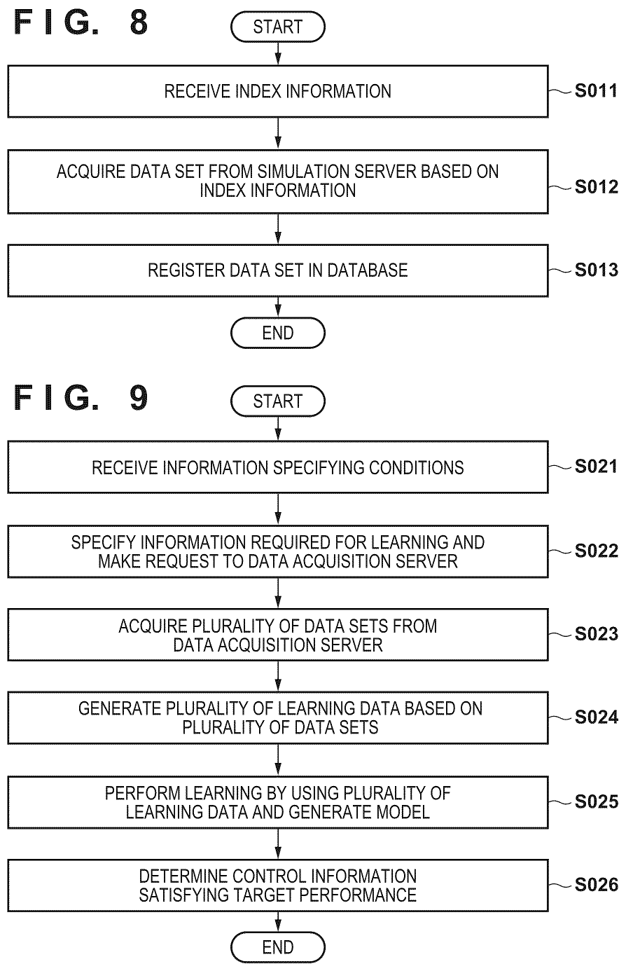

FIG. 8 exemplifies the operation of the analysis system AS in a data acquisition phase, more specifically, the operation of the data acquisition server 103. In step S011, the data acquisition server 103 receives index information assigned at the time of the execution of a simulation by the simulation server 102 from the terminal 101 or 105. In step S012, the data acquisition server 103 acquires the data set generated by the execution of the simulation specified by the index information received in step S011 from the simulation server 102. In step S013, the simulation server 102 registers the data set acquired in step S012 together with the index information in the database of the data storage unit 323.

FIG. 9 exemplifies the operation of the analysis system AS in a learning phase and an application phase, more specifically, the operation of the estimation server 104. In step S021, the estimation server 104 receives information specifying conditions for generating a model from the terminal 101 or 105. In step S022, the estimation server 104 specifies information required for learning, more specifically, information specifying an explanatory variable and an objective variable based on the information received in step S021 and requests the data acquisition server 103 to provide the information. In response to this request, in the data acquisition server 103, the data operation unit 322 searches for or extracts a plurality of data sets registered or accumulated in the database of the data storage unit 323 and provides the information to the estimation server 104.

In step S023, the estimation server 104 acquires a plurality of data sets provided from the data acquisition server 103. The estimation server 104 checks whether the plurality of data sets provided from the data acquisition server 103 match learning, for example, whether the number of data sets is appropriate. If there is a deficiency, the estimation server 104 may notify the data acquisition server 103 of the corresponding information. In response to this notification, the data acquisition server 103 can provide an additional data set or a plurality of new data sets to the estimation server 104.

In step S024, in the estimation server 104, the data generating unit 332 generates a plurality of learning data based on the plurality of data sets. This processing can include, for example, a process of dividing a plurality of data sets into a group of data sets for normal learning and a group of data sets for verification. The ratio between the number of data sets for normal learning and the number of data sets for verification can be, for example, data set count for normal learning: data set count for verification=8:2 or 7:3. However, this is not exhaustive. Data sets for normal learning and verification can be determined by random sampling. The model generating process in step S025 may include a process of verifying the model tentatively generated by learning. The above data sets for verification can be used for this verification. If the verification result is failure, learning can be performed again by, for example, changing the learning method. Specific algorithms for machine learning include, for example, a nearest neighbor method, a Naive Bayes method, a decision tree method, and a support vector machine method. Such algorithms also include deep learning that autonomously generates a feature amount and coupling weight coefficients for learning by using a neural network. Some of the above algorithms which can be used can be applied to this embodiment as appropriate.

Step S026 is an example of an application phase, in which the estimation server 104 can determine the value of an explanatory variable so as to satisfy target performance by using the model generated in step S025 and provide the value of the explanatory variable to the terminal 101 or 105. Alternatively, the estimation unit 334 can determine the value of an objective variable based on the value of the explanatory variable provided from the terminal 101 or 105 by using the model generated in step S025 and provide the value of the objective variable to the terminal 101 or 105. The above method is advantageous in analyzing a process in a short period of time at low cost.

Processing from the data acquisition phase to the learning phase described with reference to FIGS. 7, 8, and 9 will be described along with a specific example of a database. FIG. 24 exemplifies the parent database configured by the data storage unit 323 of the data acquisition server 103. The first column of the parent database can be index information (Index). The index information can include, for example, character strings indicating conditions for the execution of a simulation. Mold information (mold info), substrate information (substrate info), gas information (gas info), imprint material information (resist info), apparatus information (apparatus info), and objective variable information (objective variable info information) can be recorded on the same row in correspondence with index information.

Mold information is information associated with a mold. Substrate information is information associated with a substrate (wafer). Gas information is information associated with the gas supplied in a space between a substrate and a mold. Imprint material information is information associated with an imprint material. Apparatus information is information associated with the operation of an imprint apparatus that executes an imprint procedure. The imprint procedure can be a procedure of arranging an imprint material on a substrate, bringing the imprint material into contact with the mold so as to form a liquid film of the imprint material, forming a cured film of the imprint material by curing the liquid film, and separating the cured film from the mold.

Mold information, substrate information, gas information, imprint material information, apparatus information, and objective variable information each can be called a module. Each module can be assigned with a number called Key (identifier). Key is used to refer to detailed information corresponding to Key.

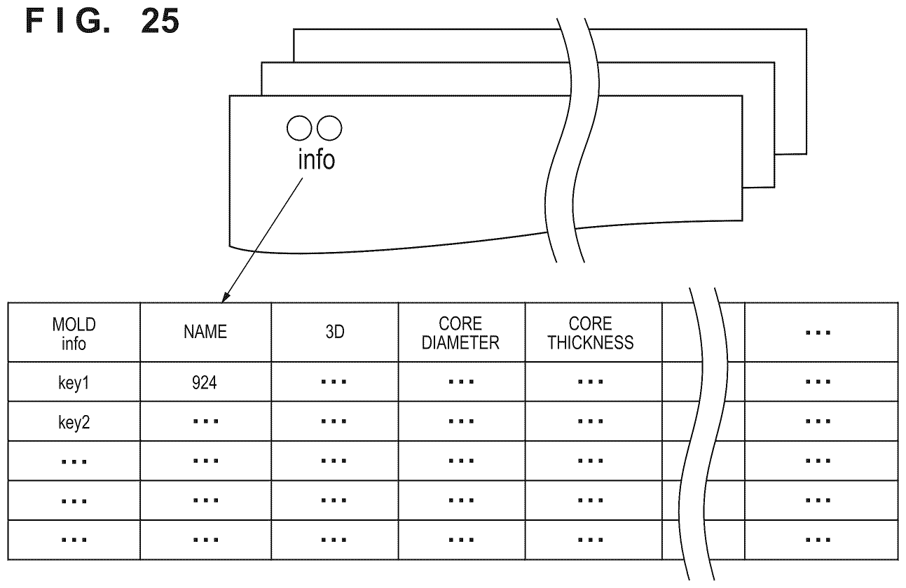

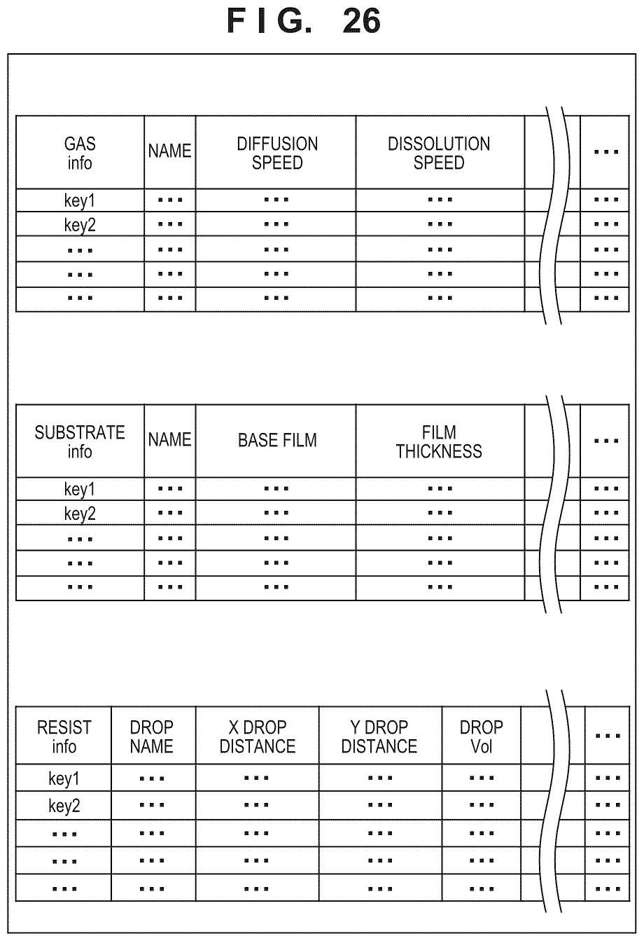

Key assigned to each module will be described. FIG. 25 schematically shows a database list or template collecting various conditions for each module. FIG. 26 schematically shows a database list of mold information (mold info). The first column is assigned with Key of mold information (mold info). Various conditions associated with the Key, such as a mold name, a mold dimension, a core diameter, and a core thickness, are arranged in the same row. The same applies to the remaining modules. FIG. 26 schematically shows gas information (gas info), substrate information (substrate info), and imprint material information (resist info).

The operations shown in FIGS. 7 and 8 will be described along with the examples shown in FIGS. 24, 25, and 26. The operation of the simulation server 102 will be exemplarily described first with reference to FIG. 7. In step S001, the simulation server 102 receives index information (Index) and information specifying an input (an input for a simulation) to the simulator 312 from the terminal 101 or 105. In step S002, the simulation server 102 makes the simulator 312 execute the simulation based on the information received in step S001. In step S003, the simulation server 102 saves data sets including inputs and outputs in the simulation in step S002 in the data storage unit 313 in correspondence with the index information (Index).

The operation of the data acquisition server 103 will be exemplarily described with reference to FIG. 8. In step S011, the data acquisition server 103 receives the index information (Index) assigned at the time of the execution of the simulation by the simulation server 102 from the terminal 101 or 105. In step S012, the data acquisition server 103 acquires, from the simulation server 102, the data sets generated by the execution of the simulation specified by the index information (Index) received in step S011. In step S013, the simulation server 102 registers the data sets acquired in step S012 in the database of the data storage unit 323 in the forms exemplified by FIGS. 24, 25, and 26 in correspondence with Key of each module of the index information (Index).

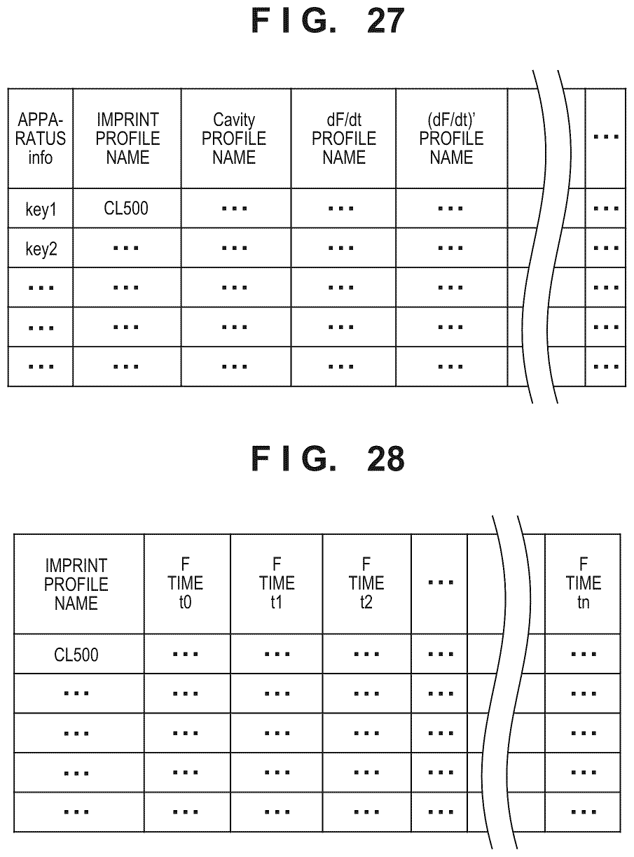

Apparatus information (apparatus info) will be described. FIGS. 27, 28, 29, and 30 exemplify databases for apparatus information (apparatus info). FIG. 27 schematically shows a database list of apparatus information (apparatus info). The first column is assigned with Key of apparatus information (apparatus info). Various profile conditions associated with the Key are arranged in the same row. In this row, the imprint profile name of an imprint head, the cavity pressure profile name, the time derivative of an imprint profile, and the ith-order time derivative (I=1, 2, . . . , n) can be arranged in this order from the left. Key enables the selection of various templates.

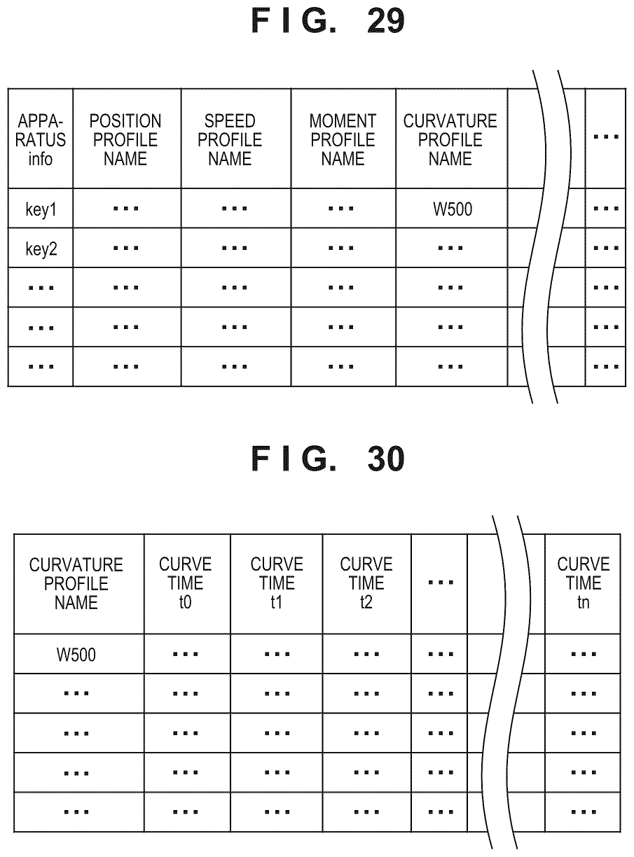

In addition, with regard to imprint profile name=CL500 in FIG. 27, there is a database exemplified by FIG. 28 that can be referred to based on CL500. In the database in FIG. 28, a Force value for each time is defined as a variable column associated with an imprint profile name. In addition, apparatus information (apparatus info) may have an intermediate data database exemplified in FIG. 29. The intermediate data database can include intermediate data output together with a simulation result from the simulator 312. The intermediate data can include, for example, the position profile of an imprint head, the speed profile of the imprint head, the moment profile of the imprint head, and the curvature profile of a mold. In the example in FIG. 29, there is curvature profile name=W500 associated with key 1 in FIG. 27. In the database in FIG. 30 to be referred to based on W500, a curvature amount for each time is defined as a variable column associated with W500.

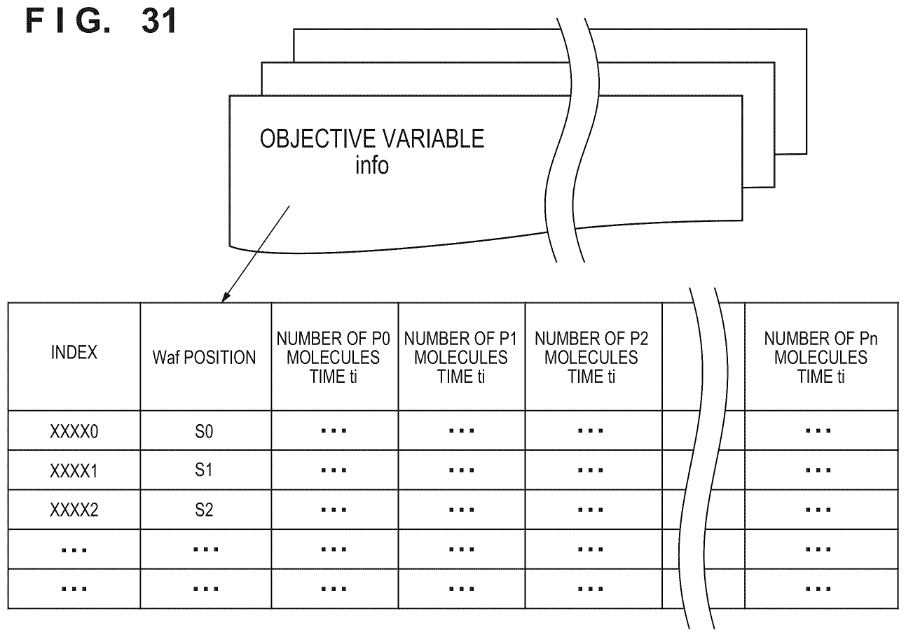

FIG. 31 schematically shows a database of objective variable information (objective variable info). Unlike other modules, in the database of objective variable information (objective variable info), the first column is index information (Index) like a parent database. In correspondence with index information (Index), a wafer position (Waf position) (which can be specified by, for example, information like S0, S1, S2, . . . indicating the positions of shot regions on a wafer) can be arranged in the same row. In addition, in correspondence with index information (Index), information indicating the number of molecules at time i (i is an arbitrary time) for each specific region (p0, p1, . . . , pn) of a mesa (pattern region) of the mold can be arranged in the same row. In this case, the number of molecules that is a typical evaluation amount has been exemplified as an objective variable. However, the evaluation amount is not limited to this. For example, the defect density in a cured film, the pass/fail determination of a mark filling image (an image indicating the filling state of an imprint material with respect to an alignment mark), or the like may be used as an objective variable. In addition, supplementary information such as place and/or time may be added to the evaluation amount. As described above, various types of evaluation amounts can be used as objective variables.

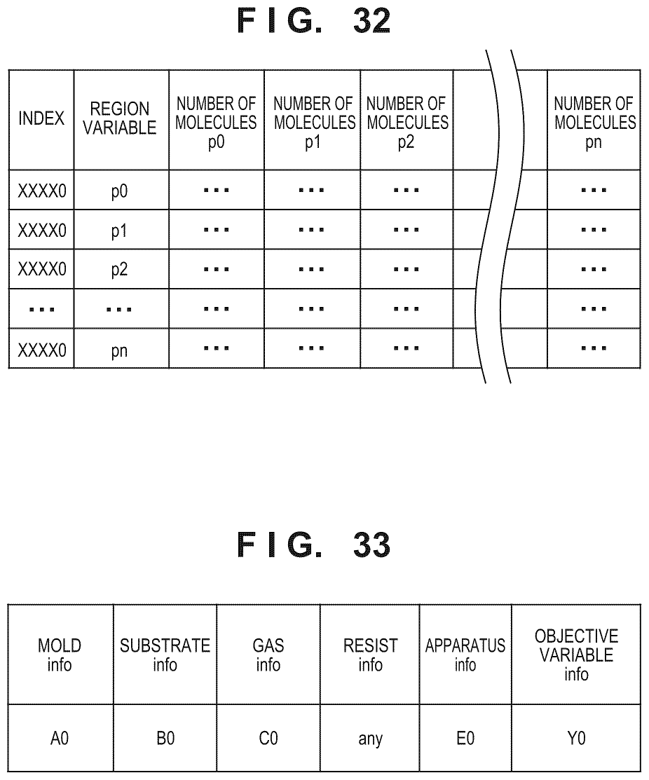

Parameterization of a mesa region of a mold will be described with reference to FIG. 32. As is also obvious from FIG. 31, wafer position information (Waf position) (S0, S1, S2, . . . ) one-to-one corresponds to index information (Index) and hence can also be one-to-one associated with an objective variable. In learning, this information can be directly used as an explanatory variable. When, however, a mesa region of a mold is parameterized, in order to implement one-to-one correspondence with objective variables, this information needs to be converted into a sequence so as to make only the objective variables corresponding to the region variable in each row correspond thereto, as shown in FIG. 32. Accordingly, when data for learning is generated, data like that exemplified in FIG. 32 can be generated.

A method of generating a plurality of learning data based on a plurality of data sets obtained from a database like that described above will be exemplarily described along with the operation shown in FIG. 9. First of all, in step S021, the estimation server 104 can receive a database list for search like that exemplified in FIG. 33 from the terminal 101 or 105 or generate such a database list based on the information received from the terminal 101 or 105. The module information names described above are arranged in the first row of the database list for search in FIG. 33. A condition (Key) can be input to each module. Referring to the parent database exemplified in FIG. 24 makes it possible to extract data sets having the same index information (Index) for a combination of a plurality of modules. Generating a database list for search like that exemplified in FIG. 33 can obtain a data set for learning (optimization). In the example in FIG. 33, providing Key to imprint information (resist info) as “any” makes it possible to search for only data matching all the conditions in the database list (template) of imprint information and other module conditions and use the found data for learning.

An imprint apparatus will be exemplarily described below as an example of a semiconductor device manufacturing apparatus that executes a process for manufacturing a semiconductor device.

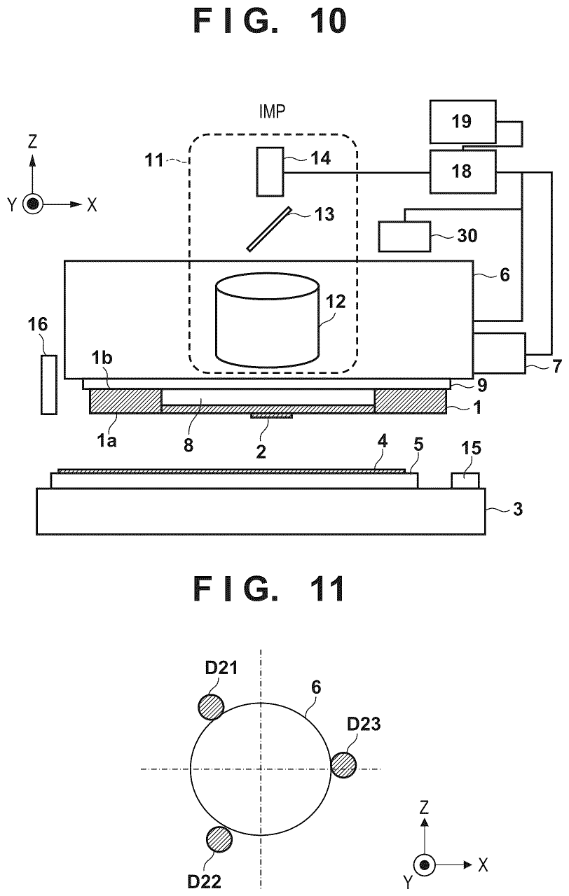

FIG. 10 is a schematic view illustrating configurations of an imprint apparatus IMP. The imprint apparatus IMP is a lithography apparatus that is employed in a lithography step as a manufacturing step of a semiconductor device, a magnetic storage medium, a liquid crystal display element, or the like and forms a pattern on a substrate. The imprint apparatus IMP functions as a molding apparatus configured to perform a molding process of molding an imprint material that is a composition on a substrate by using a mold. In this embodiment, the imprint apparatus IMP brings an imprint material supplied onto a substrate into contact with a mold and gives curing energy to the imprint material, thereby forming a pattern of a cured product to which the pattern of the mold is transferred. Note that the mold is also called a mold, a template, or a master.

As the imprint material, a material (curable composition) to be cured by receiving curing energy is used. An example of the curing energy that is used is electromagnetic waves, heat, or the like. As the electromagnetic waves, for example, infrared light, visible light, ultraviolet light, and the like selected from the wavelength range of 10 nm (inclusive) to 1 mm (inclusive) is used.

The curable composition is a composition cured by light irradiation or heating. The photo-curable composition cured by light irradiation contains at least a polymerizable compound and a photopolymerization initiator, and may contain a nonpolymerizable compound or a solvent, as needed. The nonpolymerizable compound is at least one type of material selected from a group comprising of a sensitizer, a hydrogen donor, an internal mold release agent, a surfactant, an antioxidant, a polymer component, and the like.

The imprint material may be applied in a film shape onto the substrate by a spin coater or a slit coater. The imprint material may be applied, onto the substrate, in a droplet shape or in an island or film shape formed by connecting a plurality of droplets using a liquid injection head. The viscosity (the viscosity at 25° C.) of the imprint material is, for example, 1 mPa·s (inclusive) to 100 mPa·s (inclusive).

As the substrate, glass, ceramic, a metal, a semiconductor, a resin, or the like is used, and a member made of a material different from that of the substrate may be formed on the surface of the substrate, as needed. More specifically, examples of the substrate include a silicon wafer, a semiconductor compound wafer, silica glass, and the like.

As shown in FIG. 10, the imprint apparatus IMP includes a substrate stage 3, a substrate chuck 5, an imprint head 6, a pressure adjusting unit 7, and a shielding member 9. The imprint apparatus IMP also includes a relay optical system 12, a bandpass filter 13, an observation unit 14, a first measuring unit 15, a second measuring unit 16, a control unit 18, a storage unit 19, and an irradiation system 30.

In the specification and the accompanying drawings, directions will be indicated on an XYZ coordinate system in which directions parallel to the surface of a substrate 4 are defined as the X-Y plane. Directions parallel to the X-axis, the Y-axis, and the Z-axis of the XYZ coordinate system are the X direction, the Y direction, and the Z direction, respectively. A rotation about the X-axis, a rotation about the Y-axis, and a rotation about the Z-axis are θX, θY, and θZ, respectively. Control or driving (moving) concerning the X-axis, the Y-axis, and the Z-axis means control or driving (moving) concerning a direction parallel to the X-axis, a direction parallel to the Y-axis, and a direction parallel to the Z-axis, respectively. In addition, control or driving concerning the θX-axis, the θY-axis, and the θZ-axis means control or driving concerning a rotation about an axis parallel to the X-axis, a rotation about an axis parallel to the Y-axis, and a rotation about an axis parallel to the Z-axis, respectively.

A mold 1 has a rectangular outer shape and is formed from a quartz substrate. The mold 1 has a mesa region (pattern region) 2 in a central portion of a first surface 1a on the substrate side on which a pattern (concave-convex pattern) to be transferred on a substrate 4 is formed. The mesa region 2 is formed to be higher than its surrounding region, that is, to have a stepped structure, in order to prevent regions other than the mesa region 2 from coming into contact with the substrate 4 when forming an imprint material on the substrate. The mold 1 has a core out 8 (recess structure), which is a cylindrical recess portion, in a second surface 1b on the opposite side to a first surface 1a including the mesa region 2. The core out 8 is also called a cavity and is generally formed such that the center of the core out 8 overlaps the center of the mesa region 2.

The imprint head 6 holds, for example, the mold 1 through the mold chuck 9 that vacuum-chucks or electrostatically chucks the mold 1. The imprint head 6 functions as a pressing portion that brings the mold 1 chucked to the mold chuck 9 into contact with the imprint material on a substrate and presses the mold 1 against the imprint material. The imprint head 6 includes a driving unit that drives (moves) the mold chuck 9. As shown in FIG. 11, the driving unit includes three-axis driving systems DZ1, DZ2, and DZ3. FIG. 11 is a view showing an example of the arrangement of the driving unit for the imprint head 6. The driving systems DZ1, DZ2, and DZ3 are formed from, for example, actuators that can be independently driven in the Z direction. The position and posture (state) of the imprint head 6 can be measured (observed) in real time by various types of sensors provided for the imprint apparatus IMP, for example, a height sensor and a power sensor (not shown) incorporated in the imprint head 6.

The pressure adjusting unit 7 adjusts the pressure of the core out 8 provided in the mold 1. The core out 8 is provided for the purpose of gradually expanding a region in contact with an imprint material from the central portion of the mesa region 2 by deforming the mold 1, more specifically, the mesa region 2 in a convex shape with respect to the substrate side when bringing the mold 1 into contact with the imprint material on the substrate. More specifically, the mesa region 2 of the mold 1 can be deformed in a convex shape with respect to the substrate side by making the pressure adjusting unit 7 increase the pressure of the core out 8 more than the outside pressure. In this manner, the pressure adjusting unit 7 functions as a deforming unit that deforms the first surface 1a in a convex shape with respect to the substrate side by applying power to the second surface 1b of the mold 1 on the opposite side to the first surface 1a. In this embodiment, the pressure adjusting unit 7 deforms the mesa region 2 (first surface 1a) in a convex shape with respect to the substrate side by adjusting the pressure of the core out 8 of the mold 1 so as to apply power to the core out 8 (second surface 1b). Air bubbles mixed in an imprint material on a substrate can be reduced by deforming the mesa region 2 of the mold 1 in a convex shape with respect to the substrate side so as to push out a gas present between the mold 1 (mesa region 2) and the substrate 4 (imprint material) to the outside (outer periphery).

In this embodiment, the relay optical system 12 is placed inside the imprint head 6, and the bandpass filter 13 and the irradiation system 30 are placed above the imprint head 6. While an imprint material on a substrate is in contact with the mold 1, the irradiation system 30 cures the imprint material by irradiating the imprint material on the substrate with light (for example, ultraviolet light) through the bandpass filter 13 and the relay optical system 12.

The observation unit 14 is placed above the imprint head 6. The observation unit 14 observes the mesa region 2 of the mold 1 and a shot region of the substrate 4 through the bandpass filter 13 and the relay optical system 12. More specifically, the observation unit 14 observes a state in which an imprint material on a substrate is spread by the mold 1 or the interference fringes formed by the narrow gap between the mold 1 and the substrate 4 and obtains observation images. The observation unit 14 also functions as an obtaining unit that obtains information concerning an increase in contact area (contact region) between the mold 1 (mesa region 2) and an imprint material on a substrate.

The substrate stage 3 holds the substrate 4 through the substrate chuck 5 that vacuum-chucks or electrostatically chucks the substrate 4. The substrate stage 3 drives (moves) the substrate chuck 5 in the X and Y directions to enable an imprint process for the entire surface (all the shot regions) of the substrate 4.

The substrate stage 3 is provided with the first measuring unit 15 that measures the height of the first surface 1a of the mold 1 on the substrate side, for example, the height of the mesa region 2. Accordingly, moving the substrate stage 3 so as to make the first measuring unit 15 pass under the mold 1 allows the first measuring unit 15 to measure the shape (surface shape) or tilt amount of the mesa region 2 of the mold 1.

The imprint apparatus IMP is also provided with the second measuring unit 16 that faces the substrate stage 3 and measures the height of the substrate 4. Accordingly, moving the substrate stage 3 so as to make the substrate 4 pass under the second measuring unit 16 allows the measuring unit 16 to measure the shape (surface shape) or tilt amount of the substrate 4.

The control unit 18 is formed from an information processing apparatus (computer) including a CPU and a memory and controls the whole imprint apparatus IMP in accordance with the programs stored in the storage unit 19. The control unit 18 controls the respective units of the imprint apparatus IMP to control the process of forming an imprint material film between the mesa region 2 and the substrate 4 by bringing the mesa region 2 (first surface 1a) of the mold 1 into contact with the imprint material (composition) on the substrate. In this embodiment, the process of forming an imprint material film is the imprint process of forming a pattern of the imprint material on each of the plurality of shot regions on the substrate. The control unit 18 can evaluate the imprint process by analyzing the image obtained by the observation unit 14 and reflect the evaluation result in the imprint process. For example, the control unit 18 obtains the measurement result (the surface shape and tilt amount of the mesa region 2 of the mold 1 and the surface shape and tilt amount of the substrate 4) obtained by the first measuring unit 15 and the second measuring unit 16 and checks the leveling state between the mold 1 and the substrate 4. The control unit 18 controls the state (position and posture) of the imprint head 6 and the state (shape) of the mold 1 through the imprint head 6 and the pressure adjusting unit 7 based on the leveling state between the mold 1 and the substrate 4.

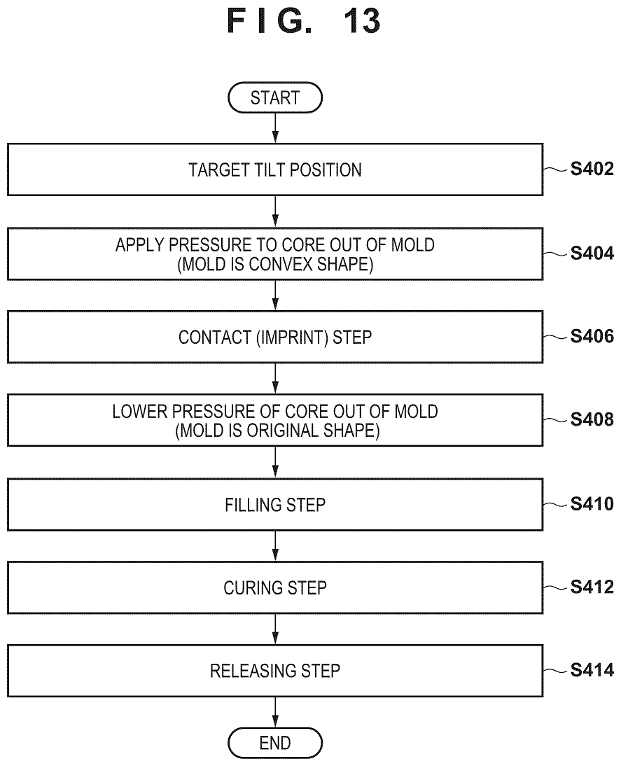

A general imprint process will be described in detail with reference to FIG. 13. FIG. 13 is a flowchart for explaining a general imprint process. An imprint process is generally performed while the leveling state between the mold 1 and the substrate 4 is maintained parallel. More specifically, making the leveling between the mesa region 2 of the mold 1 and the shot regions of the substrate 4 parallel will implement an ideal imprint process. Accordingly, the first measuring unit 15 (on the apparatus) measures the surface shape (high-direction (Z-direction) position) and tilt amount of the mesa region 2 of the mold 1 in advance, and the second measuring unit 16 globally measures the surface shape and tilt amount of the substrate 4 in advance, thereby obtaining the leveling state between the mesa region 2 and the mold 1. In step S402, a tilt position (target tilt position) as a target for the mold 1 or the substrate 4 is set, and a gap amount between the mesa region 2 of the mold 1 and the substrate 4 is also set.

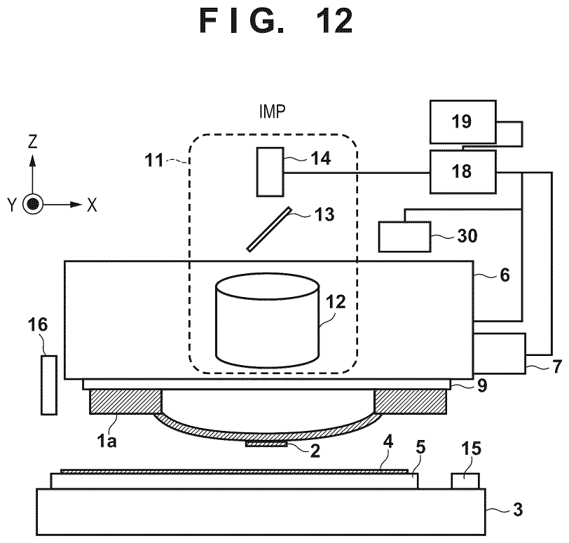

In step S404, as shown in FIG. 12, the mesa region 2 of the mold 1 bulges toward the substrate side and deformed in a convex shape by adding (applying) a pressure to the core out 8 of the mold 1 through the pressure adjusting unit 7. As described above, this operation is performed to suppress air bubbles from being confined in the imprint material on the substrate when starting to bring the mold 1 into contact with the imprint material on the substrate. Note that the deformation amount of the mesa region 2 of the mold 1, that is, the value of a pressure added from the pressure adjusting unit 7 to the core out 8 of the mold 1, is set in advance. FIG. 12 is a view showing a state in which the mesa region 2 of the mold 1 is deformed in a convex shape with respect to the substrate side in the imprint apparatus IMP.

In step S406, the contact step of bringing the mold 1 into contact with the imprint material on the substrate is started. More specifically, the imprint head 6 lowers the mold chuck 9 chucking the mold 1 in the Z direction with respect to the substrate 4 positioned in the X and Y directions by the substrate stage 3, thereby bringing the central portion of the mesa region 2 of the mold 1 into contact with the imprint material on the substrate. In addition, while this state is maintained, power control is performed to lower the mold chuck 9 in the Z direction until a predetermined power is set to spread the imprint material on the substrate up to the entire mesa region 2 of the mold 1. At this time, height (Z-direction position) control, tilt control, and power control for the mold 1 are implemented by controlling the driving of each of the driving systems DZ1, DZ2, and DZ3 constituting the driving unit for the imprint head 6.

When the imprint material on the substrate is spread to the entire mesa region 2 of the mold 1, the pressure of the core out 8 of the mold 1 is lowered (decreased) through the pressure adjusting unit 7 to restore the shape of the mesa region 2 of the mold 1 to the original shape in step S408. In step S408, the leveling state between the mold 1 and the substrate 4 is made parallel finally. In step S410, the process shifts to the filling step of filling the mold 1 with the imprint material on the substrate, and the leveling state between the mold 1 and the substrate 4 is maintained parallel for a predetermined period (until the mold 1 is filled with the imprint material on the substrate). Note that the step before transition to the filling step, more specifically, the step including step S406 and step S408, is also called a dynamic spread step.

In step S412, when the mold 1 is filled with the imprint material on the substrate, the irradiation system 30 cures the imprint material by irradiating the imprint material with light (curing step). Subsequently, in step S414, the imprint head 6 raises the mold chuck 9 in the Z direction to separate the mold 1 from the cured imprint material on the substrate (mold releasing step).

Although the general sequence of the imprint process has been described above with reference to FIG. 13, a similar sequence can be performed for the purpose of apparatus calibration even in the absence of an imprint material on a substrate. In addition, pressure control (control to deform the mold 1 in a convex shape with respect to the substrate side), height (Z-direction position) control, tilt control, and power control are stored in advance as control profiles in the storage unit 19 and executed by the control unit 18.

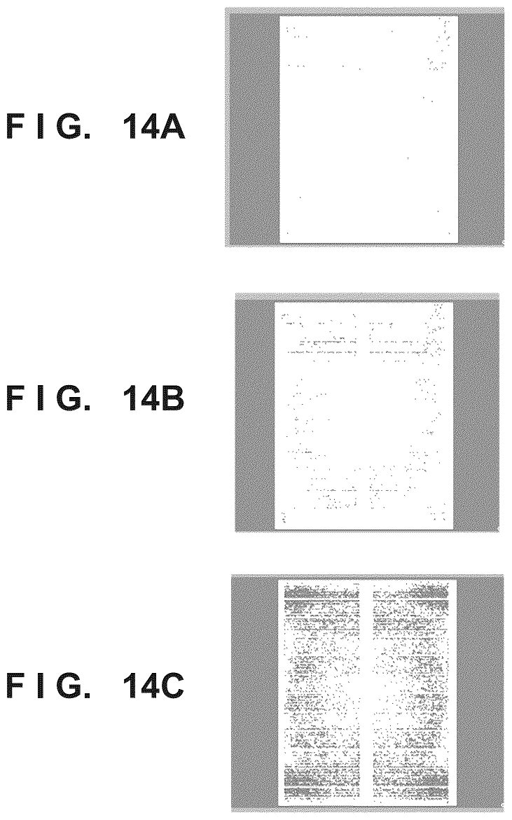

In an imprint process, in order to achieve a further improvement in productivity (throughput), it is necessary to shorten the time required for the dynamic spread step. FIGS. 14A to 14C show the experimental results obtained by observing how non-filling defects occur as the time required for the dynamic spread step is changed. FIGS. 14A to 14C respectively show the experimental results obtained when the time required for the dynamic spread step is set to 0.6 sec, 0.5 sec, and 0.4 sec. Note, however, that the time until the end of the filling step (the sum of the time required for the dynamic spread step and the time required for the filling step) is 0.8 sec, which is the same condition throughout the experiments. In this case, referring to FIGS. 14 to 14C, as the time required for the dynamic spread step shortens, non-filling defects tend to occur, resulting in an increase in (the number of) non-filling defects. Accordingly, if the time required for the dynamic spread step unnecessarily shortens, non-filling defects increase to result in a reduction in productivity.

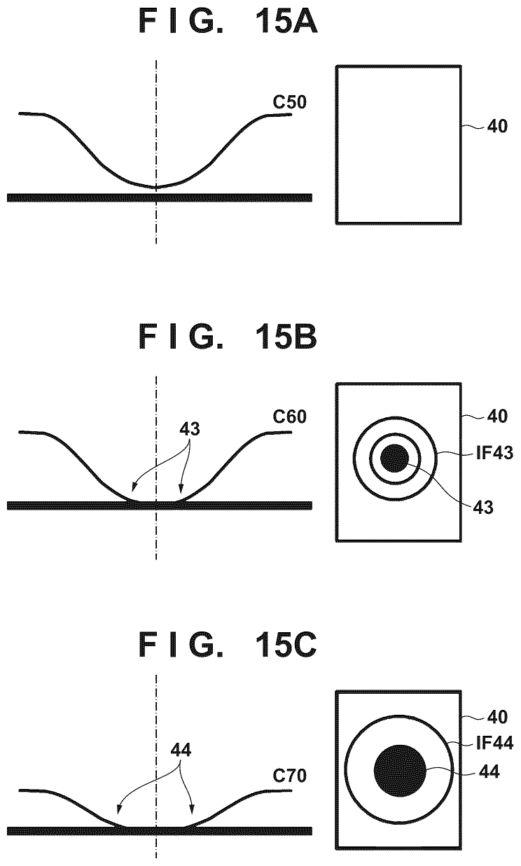

Consider the experimental results obtained by changing the time required for the dynamic spread step. FIGS. 15A to 15C respectively show the contact states between the imprint material on the substrate and the mold 1 (mesa region 2) and images 40 obtained by the observation unit 14 in accordance with the contact states and respectively show the contact states different from each other. FIGS. 15A to 15C respectively show curved surfaces 50, 60, and 70 showing the contact states different from each other and the shapes (deformation amounts) of the mold 1.

FIG. 15A shows a state in which the imprint material on the substrate is not in contact with the mold 1. In this state, the image 40 obtained by the observation unit 14 includes no interference pattern. FIG. 15B shows a state in which the imprint material on the substrate is in contact with the mold 1 with the contact diameter (distance) defined by a contact boundary 43 that is an outer edge of the region at which the imprint material is in contact with the mold 1. The image 40 obtained by the observation unit 14 in this state includes an interference pattern IF43. The interference pattern IF43 indicates that since the intervals between interference fringes near the contact boundary 43 are small, the tilt of the convex shape of the mold 1 (the curvature of the curved surface 60) near the contact boundary 43 is large.

FIG. 15C shows a state in which the imprint material on the substrate is in contact with the mold 1 with a contact diameter defined by a contact boundary 44 that is an outer edge of the region at which the imprint material is in contact with the mold 1. The image 40 obtained by the observation unit 14 in this state includes an interference pattern IF44. More specifically, FIG. 15C shows a state in which while a pressure added to the core out 8 of the mold 1 is maintained constant, the mold 1 is kept pushed into the imprint material on the substrate to make the contract boundary 43 become the contact boundary 44. The interference pattern IF44 indicates that since the interval between interference fringes near the contact boundary 44 is large, the tilt of the convex shape of the mold 1 (the curvature of the curved surface 70) further decreases as compared with the tilt of the convex shape of the mold 1 (the curvature of the curved surface 60) shown in FIG. 15B.

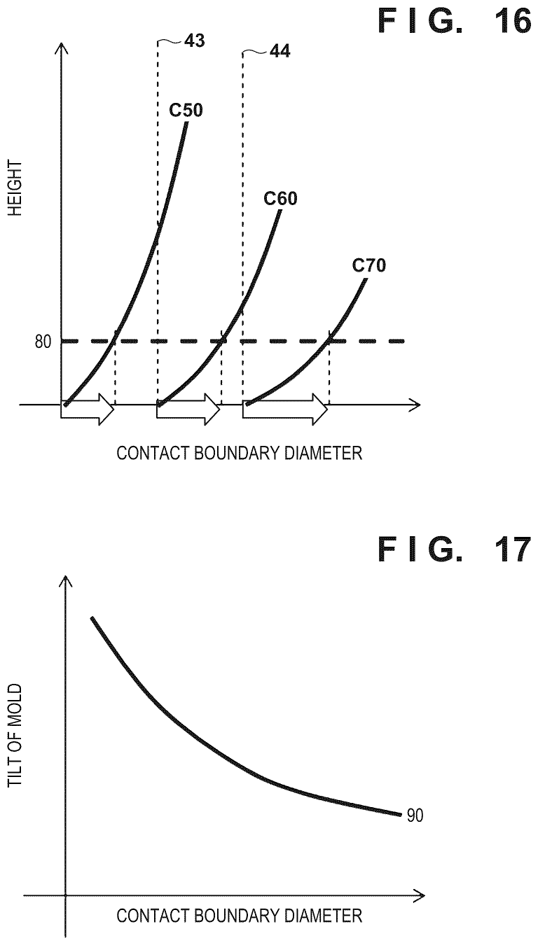

The respective states shown in FIGS. 15A to 15C will be described in detail with reference to FIGS. 16 and 17. Referring to FIG. 16, a curve C50 indicates the shape (curved surface 50) of the mold 1 in the state (FIG. 15A) in which the imprint material on the substrate is not in contact with the mold 1. A curve C60 indicates the shape (curved surface 60) of the mold 1 in the state (FIG. 15B) in which the imprint material on the substrate is in contact with the mold 1 with the contact diameter defined by the contract boundary 43. Likewise, a curve C70 indicates the shape (curved surface 70) of the mold 1 in the state (FIG. 15C) in which the imprint material on the substrate is in contact with the mold 1 with the contact diameter defined by the contract boundary 44.

The observation of the interference patterns shown in FIGS. 15A to 15C indicates that the interval between interference fringes near the contact boundary increases with an increase in the contact area between the imprint material on the substrate and the mold 1. Referring to FIG. 16, when the height of the half-pitch of an interference fringe is indicated by a broken line 80, an increase in the interval between the interference fringes means an increase in contact boundary. In other words, as the interval between interference fringes increases, the tilts of the convex shapes of the mold 1 (the curvatures of the curved surfaces 50, 60, and 70) decrease, as shown in FIG. 17.

Referring to FIG. 17, the tilt of the convex shape of the mold 1 at the contact boundary decreases at a surrounding portion of a shot region with a large contact diameter. Accordingly, at the surrounding portion of the shot region, the relative tilt (curvature) between the mold 1 and the substrate 4 at the contact boundary decreases. This means that the effect of reducing air bubbles mixed in the imprint material on the substrate by deforming the mold 1 into a convex shape so as to push out air bubbles present between the mold 1 and the substrate 4 to the outside faster than the spreading of the imprint material decreases at the surrounding portion of the shot region.

Referring back to the experimental results described above, it can be understood from the non-filing defect distribution shown in FIG. 14C that the relative tilt between the mold 1 and the substrate 4 at the contact boundary decreases especially at the surrounding portion of the mesa region 2 (shot region) regardless of the time required for the dynamic spread step. Note, however, that such a tendency increases as the time required for the dynamic spread step is shortened. This can be explained from a physical phenomenon that increasing the speed of spreading the imprint material on the substrate increases the pressure of a gas present between the mold 1 and the substrate 4 and increases the number of molecules of the gas trapped between the mold 1 and the substrate 4 (the imprint material on the substrate).

The simulator 312 described above is configured to sufficiently accurately reproduce an operation in an actual imprint process. The simulator 312 executes a simulation of a process in the imprint apparatus IMP in accordance with the arrangement of the imprint apparatus IMP, a sequence flow, and other various types of information. In this case, the following can be exemplified as information to be considered in the simulation:
mold information (information concerning physical property values concerning the shape, dimensions, and rigidity of a mold, the pattern of the mold, and the like)
substrate information (information concerning the shape, dimensions, and layer structure (including dimensions) of a substrate, the physical property values of the film of the substrate, the topography of the substrate, and the like)
gas information (information concerning the type of gas, the physical property values of the gas which influence the filling property of an imprint material, and the like)
imprint material (resist) information (information concerning coating conditions for an imprint material, physical property values (for example, viscosity, surface tension, droplet amount, and contact angle), the film thickness of the imprint material, the array of droplets of the imprint material (a grid shape, a droplet pitch, a droplet pitch aspect ratio, and the like), and the like)
apparatus information (information concerning the specifications of the imprint apparatus (for example, the arrangement of the apparatus, an imprint sequence, and an imprint profile), information provided to the imprint apparatus for control on the imprint apparatus, and the like)

The simulator 312 can calculate, for example, the behavior of the imprint head, a change in the gas pressure around the imprint head, the flux of the imprint material under a mesa region, the deformation of a mold, and a mold curvature change at the contact boundary. This enables the simulator 312 to calculate how the space between a substrate and a mold is filled with an imprint material.

In this case, the simulator 312 can also calculate the elimination rates of a gas diffused and dissolved in a mold, an imprint material, and a film on a substrate. This enables the simulator 312 to calculate the number of molecules of the gas confined between droplets of an imprint material on a substrate in a case where the imprint material is arranged in a droplet state on the substrate. In addition, in a case where an imprint material is applied on a substrate by spin coating, the simulator 312 can calculate the number of molecules of a gas on the substrate. Furthermore, the simulator 312 can calculate, in a time series manner, an evaluation amount such as a distortion due to the influences of the homogeneity of the imprint material, the seepage of the imprint material from an edge of a mesa region, the deformation of the mold, and the topography of the substrate.

A relationship between the steps in FIGS. 7, 8, and 9 and a process in the imprint apparatus IMP will be exemplarily described below. In step S001, the following simulation conditions (input information 1) were used.

### Input Information 1

Mold: Test#924
Substrate: adhesion layer/Si substrate
Gas type: helium
Imprint profile: 343 types
Droplet type: 102 types
Droplet volume: 0.6/0.9/1.2 pl

In addition to the above information, the following information can be input (set): the dimensions of a core-out mold, the size and thickness of the substrate, the diffusion/dissolution coefficient of the gas, physical property values such as the viscosity/surface tension of the imprint material, standard parameters such as apparatus structure/performance values, and tabulated data.

An imprint profile is a command value to be given to the imprint head before dynamic spread steps S406 to S408 and filling step S410. In this case, an imprint profile with 343 conditions was prepared and calculated for one type of droplet pattern. In addition, 102 types of droplet patterns were prepared, and three types of droplet volumes were prepared for each droplet pattern. In order to make droplet volumes have random nature, in 0.6 pl setting, values were randomly provided within the range of 0.6 pl to 0.8 pl. Likewise, in 0.9 pl setting, values were randomly provided within the range of 0.8 pl to 1.0 pl. In 1.2 pl setting, values were randomly provided within the range of 1.0 pl to 1.2 pl. Index information was provided for each of the above simulation conditions, a total of 1055 conditions.

In step S002, a simulation was executed under the 1055 conditions, and the data sets were saved. It took about 2 to 3 hours per condition to execute calculation. In step S003, the data sets obtained by the simulation were saved in a simulation server in correspondence with index information.

In step S011, the data acquisition server side was made to receive the index information described above. In step S012, a data set was extracted from the simulation server based on the index information and saved in the data storage unit of the data acquisition server. Variable information for a simulation which was to be extracted was saved as a list in the data storage unit of the data acquisition server. A data set was extracted for each index based on the list. A variable information list can include some of the variables set for the simulation and various evaluation amounts. Evaluation amounts can include, for example, a trace associated with the motion (position and force) of the imprint head, the deformation of a mold, and a mold curvature at a contact boundary. Evaluation amounts can also include, for example, the film thickness of an imprint material, the pressure of a gas, distortion, and the number of molecules of a gas confined between droplets. In step S013, the extracted variables were registered in the database in correspondence with the index information. The variables include explanatory variables and objective variables.

In step S021, the estimation server 104 was made to receive information concerning conditions under which the user actually wants to perform modeling. In this case, the following modeling conditions (input information 2) were used:

### Input Information 2

Mold: Test#924
Substrate: adhesion layer/Si substrate
Gas type: helium
Imprint profile: normal
Droplet type: 102 types
Droplet volume: 0.6/0.9/1.2 pl
Evaluation value: number of molecules between droplets

In step S022, variables to be learned from input information 2 are combinations of all the droplet types and all the droplet volumes and the numbers of molecules between droplets which correspond to the combinations. These variables are used as combination information of explanatory variables and objective variables to form a list. Alternatively, if an input information template has already been saved, the saved template can be read. Subsequently, as has been described above, in steps S023 to S025, a plurality of data sets were extracted from the data acquisition server, a plurality of learning data were generated by dividing the extracted data sets into data sets for learning and data sets for verification, and a model was generated by performing learning by using the learning data. An objective variable in this case was an index indicating filling performance, that is, the number of molecules between droplets. A set of the numbers of molecules can be converted into the number of defects by setting a threshold TH, extracting defects by binarizing the numbers of molecules using the threshold TH, and counting the number of defects. However, an appropriate threshold is considered to depend on a process and measurement conditions.

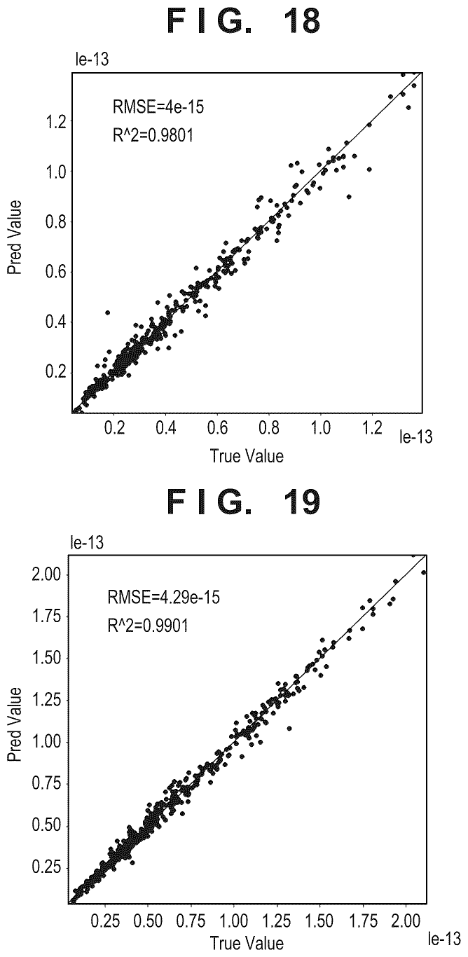

FIG. 18 shows the result obtained by verifying the model generated by learning using a plurality of learning data. The abscissa represents objective variable data of data for verification, which are considered to be true values. The ordinate represents the estimation values calculated by using the generated model. FIG. 18 shows the values of correlation coefficient R\hat{ }2 and a root-mean-square error RMSE between the abscissa and the ordinate. That the correlation coefficient is 0.98 means that a simulation result can be estimated with high prediction accuracy. That is, in the region of the input conditions this time, estimating the numbers of molecules between droplets in many unknown droplet patterns that seem to have good filling performance with high probability makes it possible to select optimal droplets from the droplet patterns.

In addition, similar learning was performed concerning droplets in a different imprint profile. Other conditions are the same as those in input information 2:

### Input Information 3

Mold: Test#924
Substrate: adhesion layer/Si substrate
Gas type: helium
Imprint profile: fast imprint profile
Droplet type: 102 types
Droplet volume: 0.6/0.9/1.2 pl Evaluation value: number of molecules between droplets

Input information 3 was set to perform learning upon selecting a profile for imprinting faster than the above imprint profile, that is, a profile with a short imprint time.

FIG. 19 shows the result obtained by verifying the model generated by learning complying with input information 3. The abscissa represents objective variable data of data for verification, which are considered to be true values. The ordinate represents the estimation values calculated by using the generated model. The result in FIG. 19 was obtained concerning both the values of a correlation coefficient and RMSE as compared with FIG. 18. As the imprint profile was sped up, an increasing tendency was found in the numbers of molecules between droplets as a whole. This increase in variance is considered to improve the correlation coefficient.

With regard to the two models learned in this embodiment, sorting and comparing droplet patterns of the currently used droplet types with good filling performance revealed that almost the same droplet patterns ranked high, and the rank order slightly changed. This comparison result makes it possible to speculate that the relationship between droplet patterns and imprint profiles is highly independent and linear in terms of filling performance. This system can be said to be a system that enables understanding of a more essential relationship between variables by comparing the predicted values of different models obtained by changing input information as in this embodiment and can provide substantially optimal conditions from the user's viewpoint as well.

The following is a description of a method of performing learning an imprint profile with respect to non-quantity variables, that is, categorical variables. A method of using an imprint profile upon converting it into a numerical quantity and the effects of the method will be described hereinafter. In step S021, input information 4 given below was used.

### Input Information 4

Mold: Test#924
Substrate: adhesion layer/Si substrate
Gas type: helium
Imprint profile: 343 types: F(t), dF/dt, t={t0, t1, . . . tn}
Droplet type: 1 type
Droplet volume: 0.6/0.9/1.2 pl
Evaluation value: number of molecules between droplets

In step S022, as explanatory variables, variables F(t) and dF/dt were used in place of the identification name of an imprint profile. An imprint profile input to the simulator is provided with a time-series command value table or high-order function coefficients in the form of a matrix. In step S022, numerical values were obtained as the variables F(t) and dF/dt at an arbitrary time. In place of the variables F(t) and dF/dt, high-order function coefficients like spline coefficients may be used. Note, however, that the number of variables increases to increase the learning cost depending on the order and the number of nodes, and hence a method using forces and their derivative values will be described hereinafter. Optimizing times with a proper number of steps enables low-cost learning. F(t) is information for controlling the driving of a mold, and dF/dt is information that can be derived from F(t).

In this example, several steps to ten-odd steps were proper numbers of steps. Even setting steps in smaller increments made no contribution to accuracy but rather prolonged the learning time. An imprint profile is sometimes a position as well as a force. In the case of a cavity, an imprint profile becomes a pressure. In addition, for example, there is a tilt or moment profile. A simulation may be executed with a combination of the above profiles.

In addition, the numbers of nth-order (n=1, 2, . . . ) derivatives and variables can be increased in place of dF/dt. All the nth-order derivatives need not be converted into variables. F(t), dF/dt, and nth-order derivatives (n=1, 2, . . . ) of F(t) can be understood as time-series data indicating a change in the state of the imprint head. An nth-order derivative of F(t) is information that can be derived from F(t).

These imprint profile variables may be relearned in step S025 if the accuracy of a tentatively generated model does not satisfy the required accuracy. This relearning is performed while, for example, the number of time steps and nth-order derivative values are increased and decreased with respect to each of F(t) and an nth-order derivative (n=1, 2, . . . ) of F(t).

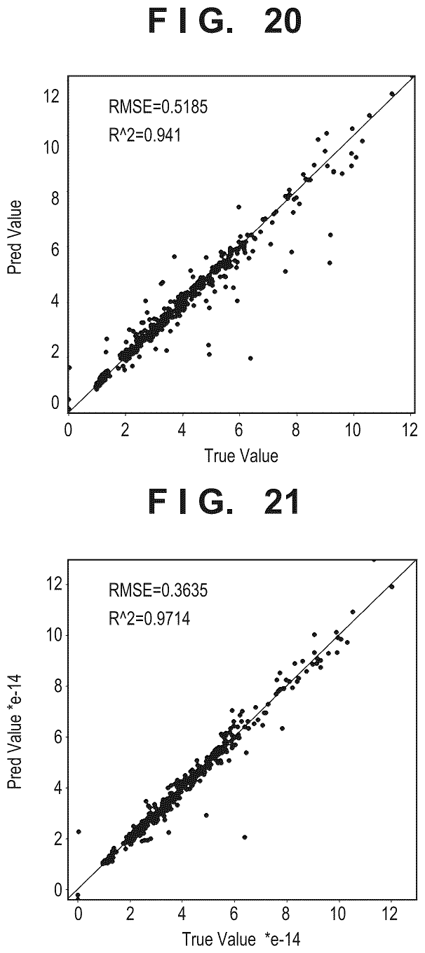

In this example, the model was verified by performing learning using both the variables, F(t) and dF/dt, under the condition of t={t0, t1, t2, . . . , t7} as step increments. FIG. 20 shows a verification result. Comparing the values obtained with a correlation coefficient of 0.94 and RMSE of 0.5185 with those in the case in FIG. 19 indicates that the results in both the cases exhibit low accuracy but exhibit levels that are usable for the prediction of optimal conditions.

It is also possible to use, as an explanatory variable, information indicating the time-series motion of the imprint head output as intermediate data of a simulation or the state of a process, such as a change in the shape of a mold, instead of the command value of an imprint profile. If, for example, an imprint profile is provided as a force command and/or a pressure command, intermediate data can be time-series data of the position information of the imprint head corresponding to the commands. With regard to the tilt and/or moment of the imprint head, if one of them is provided as a command value, the other can be intermediate data. Aside from it, the time-series data of the shape of a mold can be intermediate data. In addition, with regard to the shape of a mold, the diameter of a contact boundary which is an outer edge of a region on a substrate at which an imprint material is in contact with the mold, the curvature of the mold at the contact boundary, and the like can be intermediate data. With regard to these intermediate data, as in the technique of converting an imprint profile into an explanatory variable, an nth-order derivative (n=1, 2, . . . ) may be used as an explanatory variable.

FIG. 21 shows a verification result on a learned model in a case where the force command value of an imprint profile and the position information and speed information of the imprint head, which are intermediate data, are all explanatory variables. As indicated by a correlation coefficient of 0.97 and RMSE of 0.3635, the accuracy has greatly improved. However, learning with the use of intermediate data should be performed with caution. Conditions that can be predicted from a model are limited to conditions under which the intermediate data is used for the model in advance. That is, with regard to an unknown imprint profile, it may be difficult to perform prediction from the model. However, in a case where prediction is to be performed under limitation of a known imprint profile, accurate prediction can be performed.

The above description is about the generation of a prediction model for evaluation amounts from imprint profile information. As described above, using this model enables provision of imprint profile information satisfying demands from the user, generate an imprint profile matching an actual apparatus format from the information, and perform imprinting.

A method of further improving the prediction accuracy will be described below. In general, the filling performance of NIL is represented by the number of defects. There are places where defects tend to occur actually and places where defects do not tend to occur. As is obvious from the defect distributions in FIGS. 14A to 14C, a place where defects tend to occur is a corner portion, defects are distributed on concentric circles, and defects sometimes appear on a line on an area boundary dependent on the design of a mold pattern. Residual layer thickness uniformity (RLTU) that is the film thickness distribution of an imprint material, distortion, and the like are performance factors dependent on a place as a variable. In a simulation, sequentially analyzing the shape of a mold makes it possible to perform analysis for each intra-shot region position in time series.

In addition, the coordinates of a shot region dependent on a position in a substrate can also be considered as a variable dependent on the apparatus structure. As is also obvious from FIGS. 10 and 12, the influence of the pressure from the atmosphere or a gas to be used on an overall mold during imprinting depending on a structure around the substrate stage and the substrate chuck differs between a case where imprinting is performed near the center of the substrate and a case where imprinting is performed at a periphery of the substrate. In the case of a shot region near the center of the substrate, since the entire mold falls within the region of the substrate, the narrow gap region formed between the mold and the substrate surface during imprinting is maximum, and the influence of the pressure on the mold is large. In contrast to this, in the case of a shot region at a periphery of the substrate, the narrow gap region formed between the mold and the substrate surface is about half of the above region, and a space under a region of the mold which is not present on the substrate surface is not a narrow gap region. In this case, a gap on the mm order can occur. For this reason, the influence of the pressure on the mold is smaller than that near the center of the substrate.

In a simulation, the pressure of a gas can be analyzed in consideration of the position of a shot region on a substrate on which imprinting is to be performed and a position in the shot region. Using such information as explanatory variables makes it possible to generate a model with high accuracy that can match more detailed requests. This will be described in detail below.

Input information 5 given below was used in step S021.

### Input Information 5

Mold: Test#924
Substrate: adhesion layer/Si substrate
Gas type: helium
Imprint profile: 2 types
Droplet type: 102 types
Droplet volume: 0.6/0.9/1.2 pl
Shot region position: S0
Intra-mesa position: p0, p1, p2, p3, p4, p5, p6
Evaluation value: number of molecules between droplets

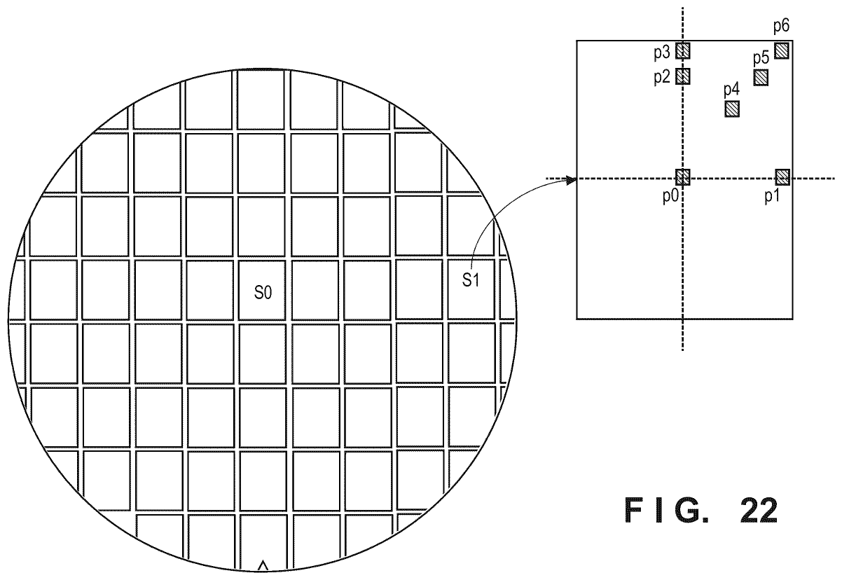

In step S022, shot region positions in the substrate (wafer) shown in FIG. 22 were specified by non-quantity values like variables S0 and S1. In each of these shot regions, seven regions p0 to p6 limited within the first quadrant were also specified by non-quantity variables in consideration of, for example, a general case where the symmetry of the design of the mold or imprinting proceeds concentrically. In step S022, set input information 5 was transferred to the data acquisition server. In step S023, data sets were extracted. At positions corresponding to p0 to p6, arbitrary evaluation amounts each present in a 2-mm region were extracted. A model was generated by performing learning using these data sets. FIG. 18 shows the result. Although not described so far, the region information p0 to p6 in the shot region were also used as explanatory variables in FIGS. 19, 20, and 21 as in FIG. 18. Note, however, that even if explanatory variables are not used as region information in a shot region, a model can be generated by learning.

In imprint lithography, in addition to the number of defects (the number of molecules between droplets), the manner of how an imprint material fills or seeps out in specific places such as a large mark and an edge of a mesa region can be set as an inspection target. The simulator 312 can have a local mode of performing calculation focusing only an arbitrary region in a mesa region in addition to a global mode of performing calculation on the overall mold. Closely coordinating information in both the modes makes it possible to implement a consistent output. For example, it is possible to designate regions each having a size of about 2 mm in a corner portion of a mesa region as a region subjected to calculation in the local mode. In this case, the flux of the imprint material in the region may be calculated by inheriting the calculation results obtained in the global mode until immediately before imprinting reaches the region. In addition, immediately after imprinting in the region, the calculation result obtained in the global mode may be coordinated with the state of the region without contradictions.

In step S001, setting local mode calculation in a specific region together with setting in the global mode at the time of an input operation makes it possible to make detailed evaluation of a filling state in the specific region. Such evaluation will be described below.

In step S021, input information 6 given below was used.

### Input Information 6

Mold: Test#924
Substrate: adhesion layer/Si substrate
Gas type: helium
Imprint profile: normal
Droplet type: 102 types
Droplet volume: 0.6/0.9/1.2 pl
Shot region position: S0
Intra-mesa position: p6 local mode region
Evaluation value: filling image classification

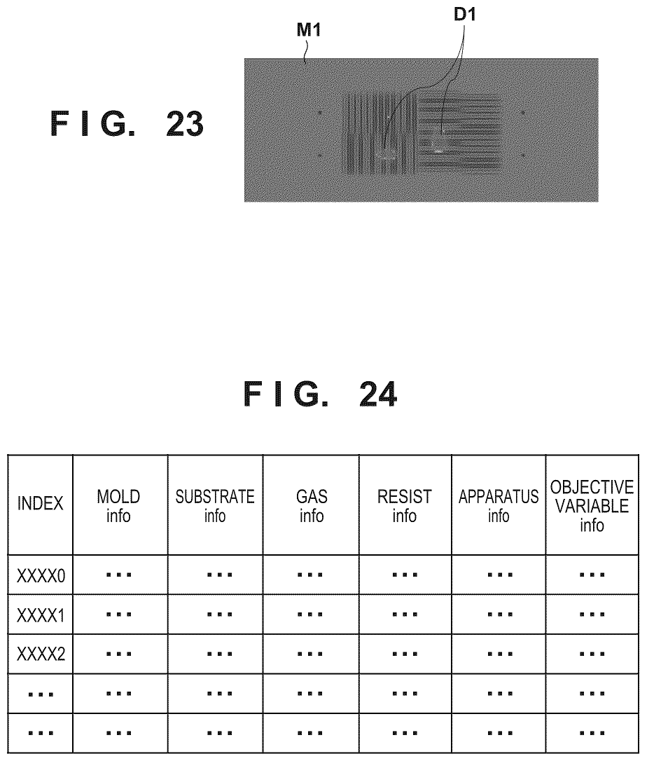

In this example, in step S025, since the evaluation value of an objective variable is used as a filling image classification, learning of a type to be classified (logistic regression) is performed unlike the regression learning in the example described above. Such learning generally uses a method of representing, by discrete numerical values instead of consecutive numerical quantities, the classification made by discriminating the filling state based on an image. FIG. 23 exemplifies a filling image of a mark region M1 output in the local mode. Two incomplete filling defect portions D1 are seen. For example, in classifying this image, the following definitions are made: objective variable {0: good, 1: slight incomplete filling, 2: medium incomplete filling defect, 3: large incomplete filling defect, 4: small seepage, 5: medium seepage, 6: large seepage}. For example, this image is classified as 2. Such processing can be automatically performed by using a known machine learning technique for image recognition. Such a classification processing program may be processed in the data acquisition server, and the result may be saved. The data obtained by image classification using the above method is processed into an objective variable, and learning is performed by using a logistic regression model in step S026. A general regression problem and a classification problem are common to each other in that in the case of a neural network, processing progresses from the input layer to the output layer by using a nonlinear function such as a step function called an activating function, a sigmoid function, and a Relu function. On the other hand, a general regression problem and a classification problem are different from each other in the functions to be used on the output layer. The regression problem generally uses an identity function to output a calculated value itself. In contrast to this, the classification problem uses a function generally called a softmax function that outputs a probability such that the sum of the probabilities of the respective classifications becomes 1 and is designed to perform classification by the processing of selecting a higher probability.

The above method enables satisfactory prediction even in image classification and narrowing down of droplets.

The above description has been made by taking machine learning under specific process conditions as an example. It is possible to arbitrarily set information concerning mold conditions, substrate conditions, a gas type, an imprint material, and droplets. In addition, such information can be arbitrarily set in operation procedures and the like of the imprint apparatus. For example, with regard to mold conditions, a mold or core out shape and its dimensions can be arbitrarily set. Furthermore, as information such as the pattern density and pattern design of a pattern region of a mold, the design data of the mold can be obtained. With regard to substrate conditions, topography information can be input. In addition, changing the film characteristics of an underlying layer makes it possible to perform calculation while changing the gas elimination rate. With regard to a gas type, a diffusion coefficient, a dissolution coefficient, and the like can be input, and it is possible to perform calculation while changing the gas elimination rate. With regard to an imprint material, coating conditions such as spin coating and Jetting and physical properties such as viscosity and surface tension can be input. With regard to droplets, a droplet volume and a contact angle can be input.

The present invention is not limited to imprint processes and can be applied to various types of processes.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An analysis method of analyzing a process for manufacturing a semiconductor device, the method comprising:
a preparing step of preparing a plurality of data sets each including an input to a simulator that simulates the process and an output from the simulator;
a generating step of generating, based on the plurality of data sets, a plurality of learning data having, as a value of an explanatory variable, a value of information, of process information associated with at least one of control and a state of the process, to which attention is to be paid and a value of evaluation information for evaluating the process as a valued of an objective variable; and
a learning step of generating a model expressing the process by performing learning based on the plurality of learning data generated in the generating step.

2. The analysis method according to claim 1, further comprising a calculating step of calculating a value of the objective variable which corresponds to the given value of the explanatory variable by using the model.

3. The analysis method according to claim 1, further comprising a determining step of determining a value of the explanatory variable so as to satisfy target performance by using the model.

4. The analysis method according to claim 1, further comprising an accumulating step of making the simulator execute a simulation and accumulating a data set obtained by the execution of the simulation in a database, wherein the preparing step includes a searching step of searching for the plurality of data sets from the database.

5. The analysis method according to claim 4, wherein in the searching step, the plurality of data sets are searched for from the database based on the given value of the information to which attention is to be paid.

6. The analysis method according to claim 1, wherein the process includes a procedure of arranging an imprint material on a substrate, bringing the imprint material into contact with a mold so as to form a liquid film of the imprint material, forming a cured film of the imprint material by curing the liquid film, and separating the cured film from the mold.

7. The analysis method according to claim 6, wherein the information to which attention is to be paid includes at least one of mold information as information concerning the mold, substrate information as information concerning the substrate, gas information as information concerning a gas supplied to a space between the substrate and the mold, imprint material information as information concerning the imprint material, and apparatus information as information concerning an operation of an imprint apparatus that executes the procedure.

8. The analysis method according to claim 7, wherein the information to which attention is to be paid includes at least the mold information, and the mold information includes information concerning at least one of a shape of the mold, a dimension of the mold, rigidity of the mold, and a pattern of the mold.

9. The analysis method according to claim 7, wherein the information to which attention is to be paid includes at least the substrate information, and the substrate information includes information concerning at least one of a shape of the substrate, a dimension of the substrate, a layer structure of the substrate, a physical property value of the substrate, and a topography of the substrate.

10. The analysis method according to claim 7, wherein the information to which attention is to be paid includes at least the gas information, and the gas information includes information concerning at least one of a type of the gas and a physical property value of the gas that influences a filling property of the imprint material.

11. The analysis method according to claim 7, wherein the information to which attention is to be paid includes at least the imprint material information, and the imprint material information includes information concerning at least one of a coating condition for the imprint material, a physical property value of the imprint material, a film thickness of the imprint material, and an array of droplets of the imprint material.

12. The analysis method according to claim 7, wherein the information to which attention is to be paid includes at least the apparatus information, and the apparatus information includes information concerning at least one of a specification of the imprint apparatus and information provided to the imprint apparatus to control the imprint apparatus.

13. The analysis method according to claim 6, wherein the information to which attention is to be paid includes information concerning a position on the substrate at which the procedure is to be executed.

14. The analysis method according to claim 6, wherein the information to which attention is to be paid includes information concerning a region of a pattern region of the mold to which attention is to be paid.

15. The analysis method according to claim 6, wherein the information to which attention is to be paid includes information that controls driving of a mold so as to control a step of bringing the imprint material into contact with the mold so as to form a liquid film of the imprint material.

16. The analysis method according to claim 6, wherein the information to which attention is to be paid includes information derived from information that controls driving of a mold to control a step of bringing the imprint material into contact with the mold so as to form a liquid film of the imprint material.

17. The analysis method according to claim 6, wherein the information to which attention is to be paid includes time-series data indicating a change in a state of an imprint head holding the mold.

18. The analysis method according to claim 6, wherein the information to which attention is to be paid includes time-series data indicating a change in a state of the mold.

19. The analysis method according to claim 6, wherein the information to which attention is to be paid includes time-series data indicating a change in diameter of an outer edge of a region at which the imprint material is in contact with the mold.

20. The analysis method according to claim 6, wherein the evaluation information is information concerning a defect in the cured film.
